(19) United States
(12) Patent Application Publication
(10) Pub. No.: US 2023/0022024 A1
(43) Pub. Date: Jan. 26, 2023

(54) POST-ELECTION AUTOMATIC HANDOVER OF POSITION AND ADMINISTRATIVE PRIVILEGES

(71) Applicant: Bishwadeep Bhattacharyya, Hillsboro, OR (US)

(72) Inventor: Bishwadeep Bhattacharyya, Hillsboro, OR (US)

(21) Appl. No.: 17/958,350

(22) Filed: Oct. 1, 2022

(51) Int. Cl. G06Q 50/00; H04L 9/40

(52) U.S. Cl. CPC G06Q 50/01; H04L 63/102

(57) ABSTRACT

Examples are directed to a transparent manner in which position and administrative privileges are handed to a newly elected official of an online social networking group. In an example, a computer implemented method includes inviting a plurality of users of an online social group to vote for at least one candidate of one or more candidates, for a position within the online social networking group. During said inviting, the position is occupied by a first user having administrative privileges. The method further includes tabulating votes from one or more of the plurality of users, to identify a second user among the one or more candidates for the position. In an example, the method further includes, based on identifying the second user, automatically assigning administrative privileges to the second user.

### FIELD OF THE DISCLOSURE

The present disclosure relates to online social groups, and more particularly, to election process for online social groups.

### BACKGROUND

Online social groups have gained immense popularity in the last few years. Web sites and computer applications provide online social groups focusing on common interests or themes, and allow users to join online social groups or communities. For example, a neighborhood group may include people of a specific neighborhood, and a college alumni group may include alumni of the college.

Often times, one or more founders of a social networking group, or one or more users designated by the founders, have administrative privileges for managing the group. There may not be a fair, transparent, and democratic process to conduct an election to elect one or more users for one or more executive roles within the group, and/or to smoothly handover or transfer administrative privileges to the newly elected users.

### BRIEF DESCRIPTION OF THE DRAWINGS

So that the manner in which the described features of particular embodiments can be understood in detail, a more particular description of particular embodiments, may be had by reference to embodiments, some of which are illustrated in the appended drawings. It is to be noted, however, that the appended drawings illustrate only particular embodiments and are therefore not to be considered limiting of its scope, for the disclosure may admit to other equally effective embodiments.

FIG. 1 schematically illustrates a system environment for automatic handover of a position and/or administrative privileges to a user of a social networking group, after the user has been elected to a position of the social networking group, in accordance with an embodiment of the present disclosure.

FIG. 2 schematically illustrates a system architecture of for the social networking application, for facilitating automatic handover of a position and/or administrative privileges to a user of the social networking group, after the user has been elected to a position of the social networking group, in accordance with an embodiment of the present disclosure.

FIG. 3 illustrates a method for facilitating automatic handover of a position and/or administrative privileges to a user of the social networking group, after the user has been elected to a position of the social networking group, in accordance with an embodiment of the present disclosure.

FIGS. 4A and 4B illustrate example timelines for the various processes discussed with respect to FIG. 3, in accordance with an embodiment of the present disclosure.

### DETAILED DESCRIPTION

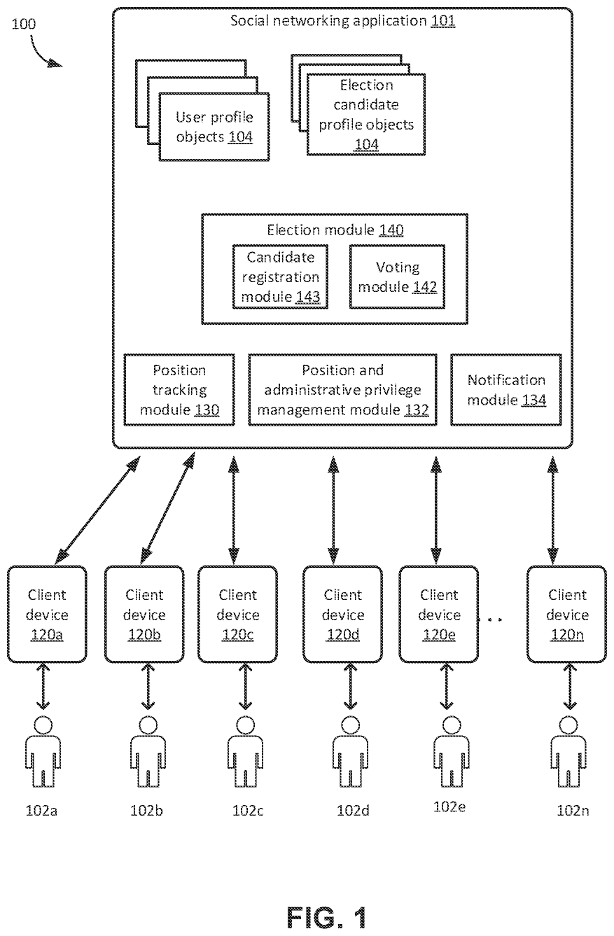

FIG. 1 schematically illustrates a system environment 100 for automatic handover of a position and/or administrative privileges to a user of a social networking group, after the user has been elected to a position of the social networking group, in accordance with an embodiment of the present disclosure.

Various figures, including FIG. 1, use like reference numerals to identify similar elements. A letter after a reference numeral, such as “102a,” indicates that the text refers specifically to the element having that particular reference numeral. A reference numeral in the text without a following letter, such as “102,” refers to any or all of the elements in the figures bearing that reference numeral. Thus, user 102a refers to a specific user, while user 102 or users 102 refer to respectively a singular and plural of the users of the social networking application 101.

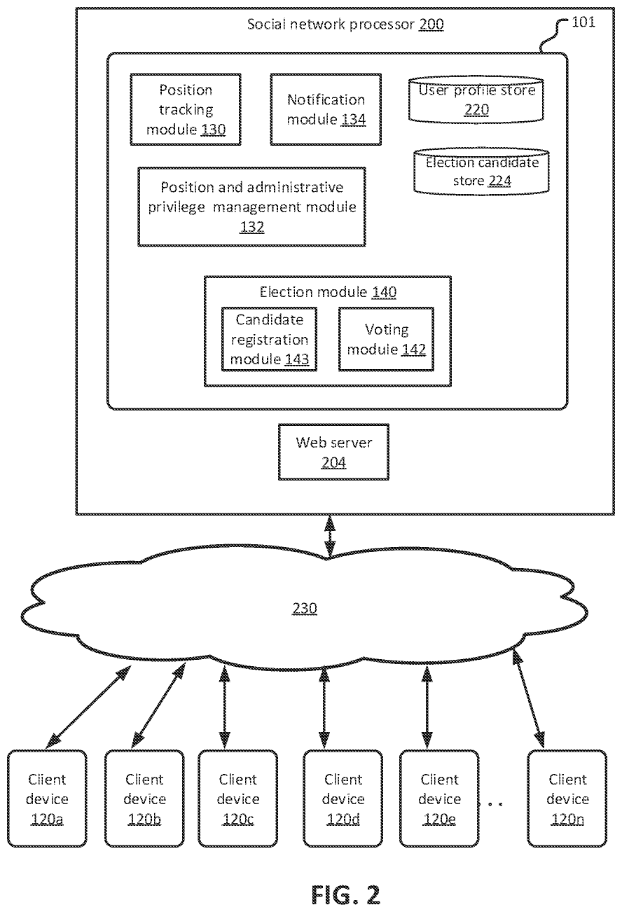

The environment 100 includes the social networking application 101 (henceforth also referred to herein as “application 101”), which may be a cloud based social networking application (e.g., hosted by a social network processor 200, discussed with respect to FIG. 2). In an example, the social networking application 101 may be for forming an online social networking group. Any appropriate type of groups may be possible, such as a group in which like-minded people (e.g., sharing a similar profession, similar education level, similar neighborhood, similar school, similar interest, etc.) can participate. Some examples of such online social networking groups include a neighborhood group, a group of engineers, a group of students and/or alumni of a school, college, or university, an online club or community based on a specific interest or hobby (such as a photography club, a drama club, or a football club), a group of fans (e.g., fans or supporters of a soccer club, or fans of a music or film personality), or another such appropriate online social networking group.

Users 102a, 102b, 102c, . . . , 102n interact with the application 101 using corresponding client devices 120a, 120b, 120c, . . . , 120n. Note that although a specific user 102 is illustrated to use a specific device to access the application 101, a user can use any of the devices 120 to access the application. The client devices 120 may have any form factor and can be any appropriate electronic devices that can be used to access the application 101, such as a personal computer (PC), a desktop computer, a laptop computer, a notebook, a tablet PC, a personal digital assistant (PDA), a mobile telephone, smart phone, and/or appropriate consumer electronic devices that can be used to access and interact with the application 101. The client devices 120 may execute an appropriate operating system, for example, a Microsoft Windows-compatible operating system (OS), Apple OS X, and/or a Linux distribution, for example. In some embodiments, the client device 120 may use a web browser as an interface to interact with the social networking system. In other embodiments, specialized application software such as native applications on a mobile device may be used as an interface to interact with the social networking system.

The application 101 facilitates communication and/or online interaction among the users 102. The application 101 can have one or more specific goals, based on the type of the application. For example, if the application 101 is for computer science researchers, the application 101 can allow sharing of research ideas. On the other hand, if the application 101 is for chess players, the application 101 can allow the users 102 to play online chess games among themselves. Thus, the functionalities provided by the application 101 are based on the type of application, and may be implementation specific.

The application 101 for the online social group may have different positions or posts, in which corresponding users may be elected. Examples of such positions include a position of a president of the group, a vice president, a network administrator, a social committee head, a treasurer, an administrator, and/or the like. A user elected for a position may have one or more corresponding administrative privileges, e.g., depending on the position and the governing principles or bylaws of the group. Merely as an example, a vice president of the group can add new users to the application 101 (e.g., allow or deny new user request), whereas a president may be allowed to add new users to the group, as well as oust or expunge a current user of the group (e.g., due to violation of one or more laws of the group by the user).

Thus, each position within the online social group of the application 101 is associated with corresponding administrative privileges, where the specific administrative privileges assigned to a specific position (such as administrative privileges assigned to a position or post of a president of the online social group) are implementation specific, and based on a nature of the group.

In one embodiment, a position tracking module 130 of the application 101 keeps track of various positions. For example, the position tracking module 130 may maintain a list of various positions, and a corresponding list of users filling those positions. For example, the position tracking module 130 may track that a first user is currently in a position of a president, a second user is currently in a position of a vice president, and a third user is currently in a position of a network administrator of the social networking group. In an event of a change in a user assigned to a specific position (e.g., due to an election, or a resignation of a user from a position, for example), the position tracking module 130 keeps track of such changes as well.

In one embodiment, a position and administrative privilege management module 132 manages administrative privileges associated with various positions. For example, in response to the position tracking module 130 indicating that a first user is elected to a position of a president of the online social group, the position and administrative privilege management module 132 assigns the position of the president and corresponding administrative privileges to the first user. Similarly, in an event of change of a user for a position (e.g., due to an election, or a resignation of a user from a position, for example), the position and administrative privilege management module 132 changes the associated administrative privileges accordingly. For example, after an election for a position, the position and administrative privilege management module 132 revokes the administrative privileges for the past holder of the position, and assigns the administrative privileges to the new holder of the position, as will be discussed in further detail herein in turn.

The application 101 may have a democratic system to elect users to the various positions. For example, an election module 140 may facilitate conducting an election for various positions of the online social group. The election module 140 comprises one or more sub-modules, such as a candidate registration module 143 for registering candidates for a position prior to an election, a voting module 142 to conduct the election process (e.g., including sending invitations to various users for voting, and tabulating or counting the votes). A notification module 134 transmits notification to the users 102. The application 101 maintains user profile objects 104 representing information associated with the users 102, and maintains election candidate profile objects 104 representing information associated with candidates for one or more positions during an election of the online social group. Note that in some examples, some of the modules of the application 101 may be combined, and/or some of the modules may be split in two or more modules.

FIG. 2 schematically illustrates a system architecture of the social networking application 101, for facilitating automatic handover of a position and/or administrative privileges to a user of the social networking group, after the user has been elected to a position of the social networking group, in accordance with an embodiment of the present disclosure.

In an example, a social network processor 200 executes the social network application 101. The social networking application 101 stores user profile objects 104 in a user profile store 220. The information stored in user profile store 220 includes various relevant information about the users 102 of the social networking system 101, such as demographic information, biographic information, and/or other relevant types of descriptive information, such as educational level, gender, work experience, hobbies or preferences, home address, for example. The user profile store 220 may also store information provided by the user, such as one or more images, videos, posts, comments, and status updates shared by the users.

The election candidate store 224 stores information describing profiles of election candidates, e.g., candidates participating in an election for one or more positions of the online social group. Such information may include any resume or statement of purpose uploaded by the candidates prior to the election, candidate registration forms filled by the candidates prior to the election, and/or the like.

In one embodiment, the web server 204 links the social networking application 101 via one or more networks 230 to one or more client devices 120. In an example, the web server 204 serves web pages, as well as other related content, such as Flash, XML, or other appropriate web related content. In an example, the web server 204 enables communication between the social networking application 101 and the various client devices 120. These messages may be appropriate messages used by the social group, as well as invitation for candidate registration, invitation to vote, receiving votes cast by the users, as well as message notifying past, current, and/or past holders of various positions regarding changes in positions and/or associated changes in administrative privileges.

The network 230 may be an appropriate network, such as the Internet. In an example, the network 230 facilitates communications between the client device 120 and the social networking application 101. The network 230 may be use any standard or proprietary communication protocols for communication between the client devices 120 and the social networking application 101. Examples of such communication protocols may include, but is not limited to, worldwide interoperability for microwave access (WiMAX), Ethernet, 802.11, digital subscriber line (DSL), 3G, asynchronous transfer mode (ATM), InfiniBand, PCI Express Advanced Switching, etc. Similarly, the networking protocols used on the network 210 may include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), Long-Term Evolution (LTE), 5G, and/or other appropriate communication protocols. In an example, data exchanged over network 230 may be represented using technologies and/or formats including the hypertext markup language (HTML), the extensible markup language (XML), and/or other appropriate technologies and/or formats.

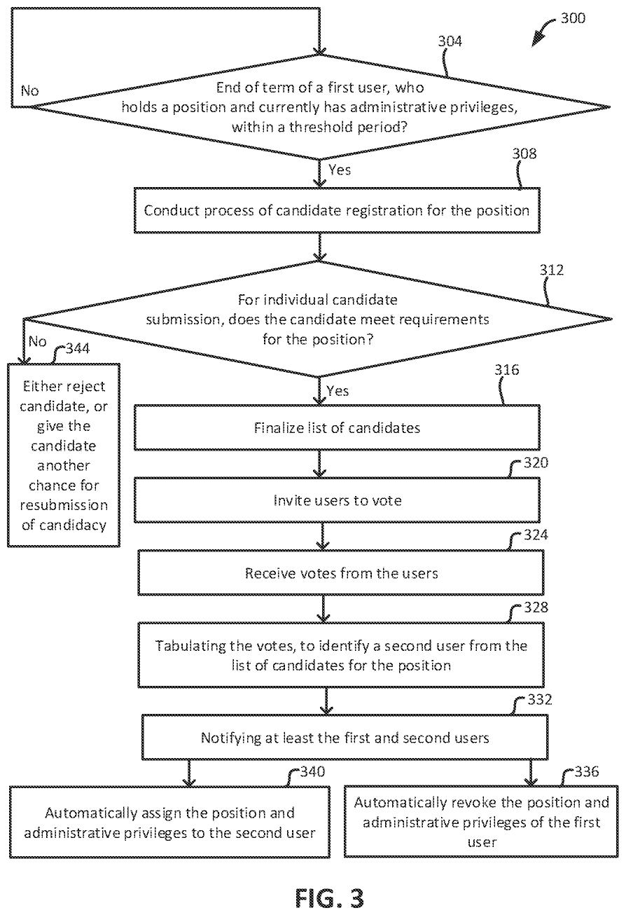

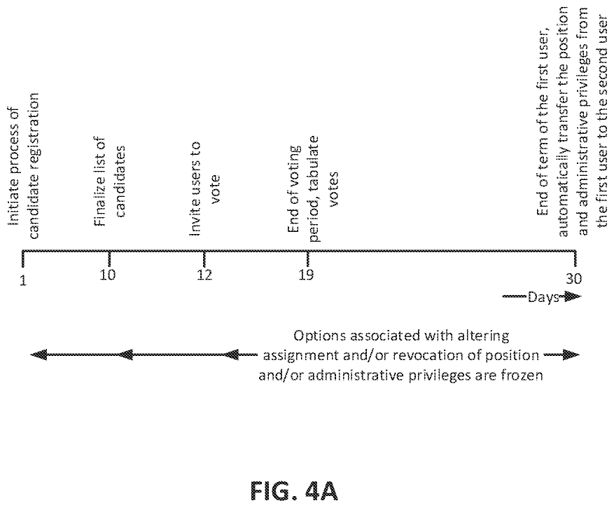

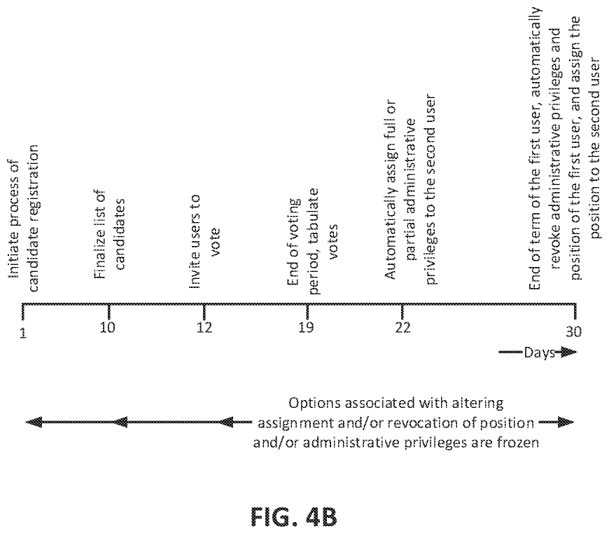

FIG. 3 illustrates a method 300 for facilitating automatic handover of a position and/or administrative privileges to a user of the social networking group, after the user has been elected to a position of the social networking group, in accordance with an embodiment of the present disclosure. FIGS. 4A and 4B illustrate example timelines for the various processes discussed with respect to FIG. 3, in accordance with an embodiment of the present disclosure. FIGS. 3, 4A, and 4B will be discussed in unison.

Note that although FIG. 3 discusses an election process and subsequent handover of administrative privileges for one position, the method 300 may be applied for more than one positions within the online social group. Furthermore, the position may be any appropriate position within the online social group, such as a position for president, vice president, network administrator, communications manager, or another appropriate position.

Furthermore, each of FIGS. 4A and 4B illustrates progression of days along the X-axis, and various events occurring through the progression of the days. Note that the timelines are merely examples, and the number of days between two events can be changed, e.g., based on a complexity, size, and/or bylaws of the online social group.

Referring to FIG. 3, at 304 of method 300, the application 101 (such as the candidate registration module 143) determines if an end of term of a first user, who holds a position and currently has administrative privileges within the online social group, is within a threshold period. The threshold period of time at 304 may be an appropriate amount of time for conducting the election process for the position. In the example of FIGS. 4A and 4B, the threshold period of time at 304 is 30 days. For example, the end of the term of the first user for the position is on day 30, and merely as an example, the threshold period of time is 30 days. Accordingly, at day 1, the process at 304 determines that the end of term of the first user is within the threshold period of time of 30 days. As will be appreciated, such number of days are mere examples.

If “No” at 304, the process 304 loops back, and keeps checking whether the term of the first user assigned to the position ends within the threshold period of time.

If “Yes” at 304, the method 300 proceeds from 304 to 308, during which process of candidate registration for the position is conducted, e.g., by the candidate registration module 143. For example, the candidate registration module 143 causes transmission of notifications (e.g., through the notification module 134) to the users 120a, . . . , 120n, that an election for the position is due soon, and interested users can register as candidates for the election. The notifications can be delivered to the users 102 via, for example, email or other types of messaging systems, such as short messaging service (SMS), multimedia messaging service (MMS), enhance messaging service (EMS), and/or via any other appropriate delivery scheme. The users 102 can respond to such notifications, and one or more users can register themselves as prospective candidates for the position.

The bylaws of the social group may include regulations that dictate the information that a user has to submit to be registered as a candidate. In an example, the current position holder(s) of the social group can set regulations as to the requirements in order to register as a candidate. For example, a user 102 may have to be a member of the group for at least a threshold period of time (such as one year or two years) to be eligible to register as a candidate. In an example, to be registered as a candidate, a user may have to submit one or more of a letter of intent, statement of purpose, resume, and/or may have to complete a series of questions. The application 101 (e.g., the candidate registration module 143) may provide an interface, through which prospective candidates can upload and fulfill such requirements. A committee that includes one or more users (or an artificial intelligence module of the application) may review information submitted by the users for candidate registration.

For example, at 312 of method 300, it may be determined if, for individual candidate submission, whether the candidate meets requirements for the position. If “No” at 312, at 344, the candidate request of the user may be rejected, or the user may be given another chance for resubmission of his or her candidacy. If “Yes” at 312, then the candidate is registered. For example, in the timeline of FIGS. 4A and 4B, day 10 is the last day of candidacy submission, and at day 10 (or one or more days after day 10), the list of candidates is finalized, illustrated as 316 in the method 300 of FIG. 3.

The method 300 then proceeds from 316 to 320, where the users 102a, . . . , 102n are invited to vote. For example, the voting module 142 causes transmission of notifications (e.g., through the notification module 134) to the users 120a, . . . , 120n, requesting the users to vote for the position. The notifications can be delivered to the users 102 via, for example, email or other types of messaging systems, such as SMS, MIMS, EMS, and/or via any other appropriate delivery scheme.

The users 102 can respond to such notifications, and one or more users vote for a candidate from the list of candidates. For example, an electronic ballot can be included within such notifications, and a user can interact with the ballot, e.g., to select a candidate from a list of candidates included in the ballot. In another example, the ballot sent through the notification may direct a user to a web portal, through which the user can select a candidate from a list of candidates. Any appropriate voting mechanism can be employed to conduct the voting process.

A pre-specified timeframe may be set for voting, and the users have to vote by that timeframe. In the example timelines of FIGS. 4A and 4B, the voting starts on day 12, when the invitations to vote are sent to the users 102. The voting ends on day 19, for example. Thus, at 320 of method 300, the application 101 (such as the voting module 142) receives votes from one or more users.

The method 300 then proceeds from 324 to 328, where the application 101 (such as the voting module 142) tabulates or counts the votes. In an example, upon tabulating the votes, the application may identify a second user from the list of candidates to have received a maximum number of votes among all candidates within the list of candidates, and accordingly, the application identifies the second user to be elected for the position. In an example, the application 101 (e.g., the position tracking module 130) identifies that the second user has to be assigned the position at the end of term of the current position holder (who is the first user), where the end of term of the current position holder is day 30 in the example timelines of FIGS. 4A and 4B.

The method 300 then proceeds from 328 to 332, where the application 101 (such as the position tracking module 130) sends notifications (e.g., through the notification module 134) to at least the first and second users regarding a schedule for position handover, and/or a schedule for handover of administrative privileges. The notifications can be delivered via, for example, email or other types of messaging systems, such as SMS, MMS, EMS, and/or via any other appropriate delivery scheme. Example schedules will be discussed herein below with respect to FIGS. 4A and 4B.

The method 300 then proceeds from 332 to 336 and 340. At 336, the application 101 (such as the position and administrative privilege management module 132) automatically assigns the position and administrative privileges to the second user, based on the second user being elected for the position. At 340, the application 101 (such as the position and administrative privilege management module 132) automatically revokes the position and administrative privileges of the first user, based on an end of the term of the first user for the position.

FIGS. 4A and 4B illustrate example timelines for processes 336 and 340 of the method 300 in further details. For example, in both FIGS. 4A and 4B, the end of term of the first user for the position is day 30 (which is merely an example).

In the example of FIG. 4A, upon the end of term of the first user on day 30 (e.g., at the end of day 30, or during a pre-specified time such as noon of day 30), the processes 336 and 340 occur concurrently, e.g., substantially at the same time. Thus, the position and administrative privileges are assigned to the second user, while at the same time, the position and administrative privileges of the first user are revoked or cancelled. Thus, there is a transfer of the position and administrative privileges from the first user to the second user.

In the example of FIG. 4B, full or at least partial administrative privileges are assigned to the second user prior to the end of the term (i.e., prior to day 30). For example, full or at least partial administrative privileges are assigned to the second user on day 22. At the end of the term, on day 30, administrative privileges and position of the first user are revoked, and the position is assigned to the second user.

Thus, in the example of FIG. 4B, there is an overlapping period (e.g., between days 22 and 30) where both the first user and the second user have at least some administrative privileges. In an example, this overlapping period of administrative privileges may be used to train and guide the second user on the handling the administrative privileges. For example, the second user may not have any prior knowledge on how to handle the administrative privileges. However, during this overlapping period, the first user may train the second user on how to handle the administrative privileges.

Note that in an example, full administrative privileges may be assigned to the second user during the overlapping period. In another example, however, partial or limited administrative privileges may be accorded to the second user during this overlapping period, and the term of the second user has not begun yet (which will begin on day 30).

In an example, the full administrative privileges have more administrative privileges than the partial administrative privileges. Note that the “full administrative privileges” does not indicate any and all administrative privileges associated with the group. Rather, the full administrative privileges associated with a position signify administrative privileges that are to be assigned to an elected user for that specific position. Partial administrative privileges associated with a position signify administrative privileges that are less than the full administrative privileges associated with that specific position.

For example, full administrative privileges for a position may allow addition of new members to the group, as well as expulsion or ousting of current members from the group. However, partial or limited administrative privileges for the position may allow addition of new members to the group, but not expulsion of current members from the group. In another example, partial or limited administrative privileges may allow the second user to review bylaws of the group, and make some changes to some sections of the bylaws, but not make changes to some other sections of the bylaws. Note that these are mere examples of partial administrative privileges, and the partial administrative privileges accorded to the second user during the overlapping period between days 22 and 30 may be implementation specific, and may depend on the nature and/or size of the online social group.

In an example, the processes 336 and 340 are performed automatically by the application 101, e.g., by the position and administrative privilege management module 132, without any intervention from the first user, who is a holder of the position prior to the end of the term. For example, the first user does not actively (or passively) participate in the process of assigning the administrative privileges to the second user. There is no manual intervention by the first user. For example, the first user does not need to manually assign the administrative privileges to the second user. Rather, the assignment process is automatic, and is governed by the bylaws and governing principles of the online social group.

For example, the application 101 automatically assigns the administrative privileges to the second user at a pre-specified date and time, as discussed with respect to FIGS. 4A and 4B. The pre-specified date and time, at which the administrative privileges are to be assigned to the second user, may be pre-specified during the candidate registration phase (e.g., between days 1 to 10), or may be pre-specified prior to the candidate registration phase. For example, the governing principles of the online social group may include clauses regarding when to assign the administrative privileges to the newly elected user, relative to the end of the term.

For example, the governing principles of the online social group may indicate that the administrative privileges are to be assigned to the newly elected user upon the end of the term of the current position holder (e.g., see FIG. 4A), or may indicate that the administrative privileges are to be assigned to the newly elected user 8 days prior (or at least 24 hours prior) to the end of the term of the current position holder (e.g., see FIG. 4B). Such options may be pre-selected when forming the online social group, and/or may be changed at any time by a position holder who has sufficient administrative privileges to change such options. The application 101 may then automatically assign the administrative privileges to the newly elected position holder, based on such selected options.

In an example, the options to alter the terms of the automatic assignment and/or revocation of the position and/or the administrative privileges may be frozen after the election process begins on day 1 of the timeline of FIGS. 4A and 4B, or may be frozen after the voting begins on day 12, or may be frozen after finalizing the list of candidates on day 10, as schematically illustrated in FIGS. 4A, 4B. So, before the options to alter are frozen, a position holder of the group, who has appropriate administrative privileges, can change the options, e.g., (i) to specify a date and/or time of assignment and/or revocation of the administrative privileges and/or the position (e.g., to specify the date and/or time relative to the end of the term), (ii) to specify whether full or partial administrative privileges are to be given to the newly elected second user prior to the end of the term (e.g., on day 22, see FIG. 4B), and/or (iii) to specify another appropriate option associated with the automatic assignment and/or revocation of the position and/or the administrative privileges. But once the options are frozen at some point of time during the election process (e.g., where the options may be frozen from day 1, day 10, or day 12, or even day 19 of the timelines of FIG. 4A, 4B), the position holder (e.g., the first user, or any other position holder) may not change these options.

The automatic assignment of the position and the administrative privileges to the newly elected position holder, and the automatic revocation of the position and the administrative privileges from the current position holder makes the handover of the position and the administrative privileges transparent, fair, and democratic. So, the automatic assignment and revocation is now not based on the goodwill or honor system of the current position holder, and takes away power from the current position holder to possibly unfairly influence such assignment and revocation. Thus, even if the first user (i.e., the current position holder) becomes hostile and doesn't want to handover the position and/or the administrative privileges to the second user (i.e., the newly elected position holder), the first user cannot interfere with the automatic assignment and/or revocation of the position and the administrative privileges. This allows for online groups to exist without being eternally dependent on the founder(s) or current leadership, and provides a democratic way of electing new leaders of the online groups, while removing nepotism or unfairness from the process, as the assignment and revocation process is automatic and not dependent on any of the current leadership.

The features and advantages described in the specification are not all inclusive and, in particular, many additional features and advantages will be apparent to someone skilled in the art in view of the drawings, specification, and claims. Some portions of this description describe the embodiments of the invention in terms of algorithms and symbolic representations of operations on information. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method comprising:
inviting a plurality of users of an online social group to vote for at least one candidate of one or more candidates, for a position within the online social group, wherein during said inviting, the position is occupied by a first user having administrative privileges;
tabulating votes from one or more of the plurality of users, to identify a second user among the one or more candidates for the position; and
based on identifying the second user, automatically assigning administrative privileges to the second user.

2. The method of claim 1, further comprising:
automatically revoking the administrative privileges of the first user.

3. The method of claim 2, wherein automatically assigning and automatically revoking comprises:
automatically revoking the administrative privileges of the first user concurrently with automatically assigning the administrative privileges to the second user.

4. The method of claim 2, wherein automatically assigning and automatically revoking comprises:
automatically assigning the administrative privileges to the second user prior to automatically revoking the administrative privileges of the first user, such that there is an overlapping time period during which the administrative privileges are shared by both first and second users.

5. The method of claim 4, further comprising:
prior to inviting the plurality of users, providing an option to configure a start of the overlapping time period; and
refraining from allowing to change the option at least during a threshold time period prior to the overlapping time period.

6. The method of claim 2, wherein a term of the first user for the position ends at a first time, wherein the administrative privileges of the first user are revoked at the first time, and wherein automatically assigning the administrative privileges to the second user comprises:
automatically assigning partial administrative privileges to the second user from a second time occurring prior to the first time; and
automatically assigning full administrative privileges to the second user from the first time.

7. The method of claim 6, further comprising:
prior to inviting the plurality of users, providing options to configure the second time and/or to configure a nature of the partial administrative privileges; and
refraining from allowing to change the options at least during a threshold time period prior to the second time.

8. The method of claim 1, wherein automatically assigning administrative privileges to the second user comprise:
automatically assigning the administrative privileges to the second user, without the first user participating, subsequent to the invitation to the plurality of users, in the process of assigning the administrative privileges to the second user.

9. The method of claim 1, wherein automatically assigning the administrative privileges to the second user comprise:
automatically assigning the administrative privileges to the second user at a date and/or time that is pre-specified prior to inviting the plurality of users to vote.

10. The method of claim 1, further comprising:
prior to automatically assigning the administrative privileges to the second user, notifying the first user and/or the second user about a date and/or time at which the administrative privileges are to be automatically assigned to the second user.

11. The method of claim 1, wherein the administrative privileges include adding a new user to the online social group, ousting a current user from the online social group, and/or changing a governing principle of the online social group.

12. A non-transitory, computer-readable storage media comprising instructions operable, when executed by one or more computing systems of an online social network, to:
while a first user is holding a position of an online social group, elect a second user for the position; and
automatically assign administrative privileges to the second user.

13. The non-transitory, computer-readable storage media of claim 12, wherein:
a term of the first user for the position ends at a first time; and
automatically assigning administrative privileges to the second user comprises automatically assigning administrative privileges to the second user at a second time that occurs at least 24 hours prior to the first time.

14. The non-transitory, computer-readable storage media of claim 13, wherein the instructions are further operable to:
prior to the election, provide an option to configure the second time; and
refrain from allowing to change the option subsequent to the election.

15. The non-transitory, computer-readable storage media of claim 13, wherein the instructions are further operable to:
automatically revoke the administrative privileges of the first user at the first time.

16. The non-transitory, computer-readable storage media of claim 12, wherein automatically assigning the administrative privileges to the second user comprises:
automatically assigning administrative privileges to the second user, without the first user participating, subsequent to the election, in the process of assigning the administrative privileges to the second user.

17. The non-transitory, computer-readable storage media of claim 12, wherein a term of the first user for the position ends at a first time, wherein automatically assigning the administrative privileges to the second user comprises:
automatically assigning partial administrative privileges to the second user from a second time occurring prior to the first time; and
automatically assigning full administrative privileges to the second user from the first time, where the full administrative privileges have more administrative privileges than the partial administrative privileges.

18. A computer system for executing operations in a social network application, the computer system comprises a social network processor implementing the social network application, the social network processor configured to implement the social networking application to:
while a first user is holding a position of an online social group, facilitate an election to elect a second user for the position; and
automatically assign administrative privileges to the second user.

19. The computer system of claim 18, wherein:
a term of the first user for the position ends at a first time; and
the administrative privileges are automatically assigned to the second user at a second time that occurs at least 24 hours prior to the first time.

20. The computer system of claim 18, wherein the administrative privileges include adding a new user to the online social group, ousting a current user from the online social group, and/or changing a governing principle of the online social group.
